(19) United States
(12) Patent Application Publication
(10) Pub. No.: US 2024/0427917 A1
(43) Pub. Date: Dec. 26, 2024

(54) CLOUD STORAGE AND FILE SHARING BASED ON PERMITTED ACCESS

(71) Applicant: Digital Site Box, LLC, Greenville, SC (US)

(72) Inventor: Thomas R. Strange, Travelers Rest, SC (US)

(21) Appl. No.: 18/337,935

(22) Filed: Jun. 20, 2023

(51) Int. Cl. G06F 21/62; G06K 7/14; H04L 9/40; H04L 67/1097

(52) U.S. Cl. CPC G06F 21/6218; G06K 7/1417; H04L 63/08; H04L 67/1097

(57) ABSTRACT

Environments for permission-based cloud storage and file sharing include a cloud-based computing network with interconnected computing devices collectively programmed to interoperate based on a computing environment coordination protocol, where at least a portion of the interconnected computing devices and related systems are configured to store location-specific files associated with worksite location(s), where the worksite location(s) include a construction site, and determine that a user is attempting to access, based on the user scanning a digital image via a user device and providing authentication credentials via the user device, the location-specific files associated with the worksite location(s). A permitted access level of the user attempting to access the location-specific files associated with the at least one worksite location is ascertained, where the ascertaining is based on the authentication credentials provided, and based on the ascertained permitted access level, corresponding access to functionality(s) associated with the location-specific files are provided.

### FIELD OF THE INVENTION

This invention relates generally to the field of cloud-based storage and file sharing, and more particularly embodiments of the invention relate to cloud storage and file sharing based on permitted access.

### BACKGROUND

Construction sites are generally required to have a job box physically located at the worksite to provide copies of documentation specific to the construction project such as permits, plans, inspections, reports, and/or other documents. State or municipal regulations, or other regulations provided by various regulatory agencies, often specify the documentation that needs to be accessible at the worksite, and in order to comply with these regulations construction companies will store the documentation in a job box in an effort to protect the physical documents safe from the elements. However, due to the physical nature of the documents that construction companies kept at the construction site, these documents may be subject to workers removing the documents from the job box and failing to return the documents. In other instances, workers (e.g., subcontractors) may lose the documents or the documents may be damaged or destroyed. For some project, such as a large-scale residential development, the construction site is active for several years, and the documentation needs to be accessible at the physical worksite throughout the duration of the project. Thus, in order to comply with the regulations, if the documents are misplaced, damaged, destroyed, etc., construction companies have to reprint copies of the documents. In some cases, like with architectural plans or site plans it can cost the construction site several hundred dollars to reprint these documents. In addition, the construction companies often regularly perform compliance checks of the construction site to verify that the appropriate documentation is accessible in accordance with the regulations.

In some cases, construction companies invest significant time and resources to ensure that the regulations are being followed and the required documentation is accessible at the construction site. Thus, the current processes and procedures are often inefficient, cumbersome, and not economical. Therefore, a need exists for improved systems and methods for providing access to documentation at construction sites.

### SUMMARY

Shortcomings of the prior art are overcome and additional advantages are provided through the provision of a computing environment for permission-based cloud storage and file sharing. The environment includes a cloud-based computing network comprising a plurality of interconnected computing devices collectively programmed to interoperate based at least in part on a computing environment coordination protocol. At least a portion of the plurality of interconnected computing devices is configured, at least in part, to store location-specific files associated with at least one worksite location, wherein the at least one worksite location comprises a construction site, and to determine that a user is attempting to access, based on the user scanning a digital image via a user device and providing authentication credentials via the user device, the location-specific files associated with the at least one worksite location. Further, at least a portion of the plurality of interconnected computing devices is configured to ascertain a permitted access level of the user attempting to access the location-specific files associated with the at least one worksite location, the ascertaining being based on the authentication credentials provided, and provide, based on the ascertained permitted access level, corresponding access to one or more functionalities associated with the location-specific files.

Additionally, disclosed herein is a computing system for permission-based cloud storage and file sharing. The system includes at least one processor, a communication interface communicatively coupled to the at least one processor, and a memory device storing executable code that, when executed, causes the at least one processor to, at least in part, detect, via a user device, a digital image being scanned that comprises machine-readable matrix code that includes embedded data modules, where the embedded data modules comprise encoded data to access a selectable link to a webpage, and display, via a user interface of the user device, the selectable link to the webpage configured to receive authentication credentials. In addition, the at least one processor is further caused to receive, via the user device, a user input selecting the selectable link to the webpage, and display, via the user interface, the webpage configured to receive authentication credentials to access location-specific files associated with a construction site. User authentication credentials are received, via the user device, from a user of the user device, and access is provided, via the user interface, to one or more functionalities related to the location-specific files associated with the construction site.

Also disclosed herein is a computer-implemented method for permission-based cloud storage and file sharing. The computer-implemented method includes, at least in part, storing location-specific files associated with at least one worksite location, wherein the at least one worksite location comprises a construction site, and determining that a user is attempting to access, based on the user scanning a digital image via a user device and providing authentication credentials via the user device, the location-specific files associated with the at least one worksite location. Further, the method includes ascertaining a permitted access level of the user attempting to access the location-specific files associated with the at least one worksite location, the ascertaining being based on the authentication credentials provided, and providing, based on the ascertained permitted access level, corresponding access to one or more functionalities associated with the location-specific files.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

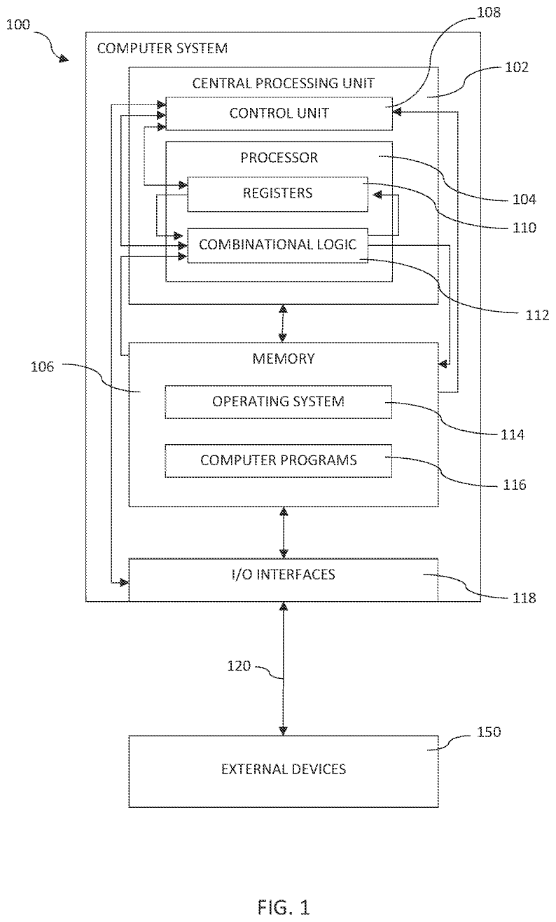

FIG. 1 depicts an example computer system configured to perform various processes described herein, according to an embodiment of the present invention;

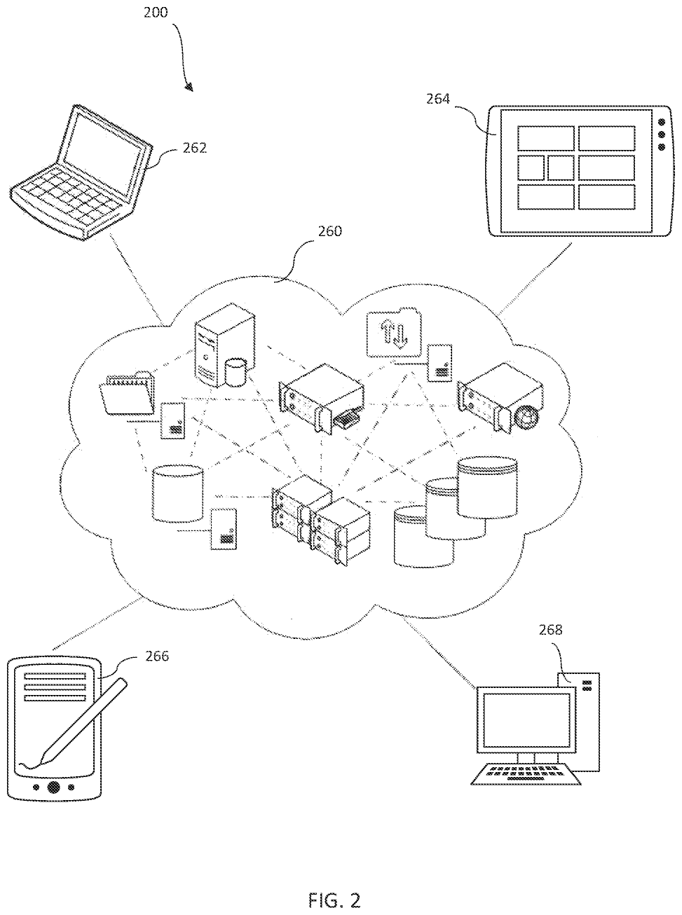

FIG. 2 depicts an example cloud computing environment, according to an embodiment of the present invention;

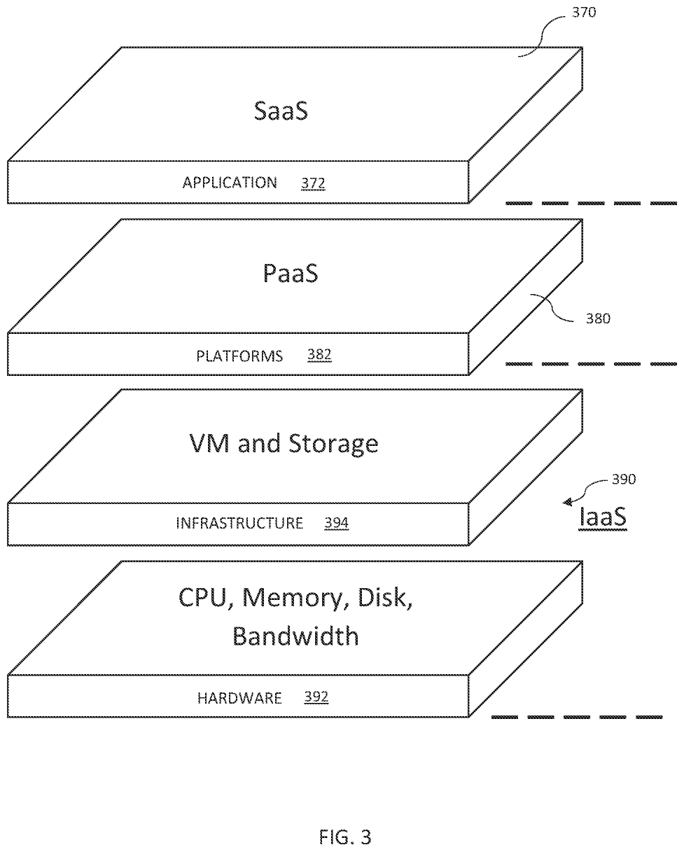

FIG. 3 depicts an example of cloud computing layers, according to an embodiment of the present invention;

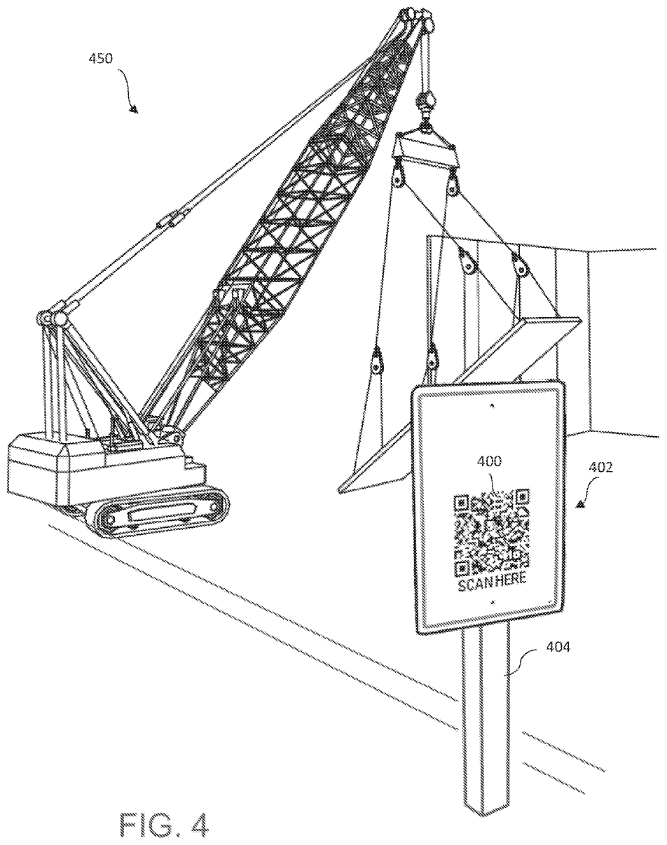

FIG. 4 depicts an example digital image displayed at a construction site, in accordance with an embodiment of the present invention;

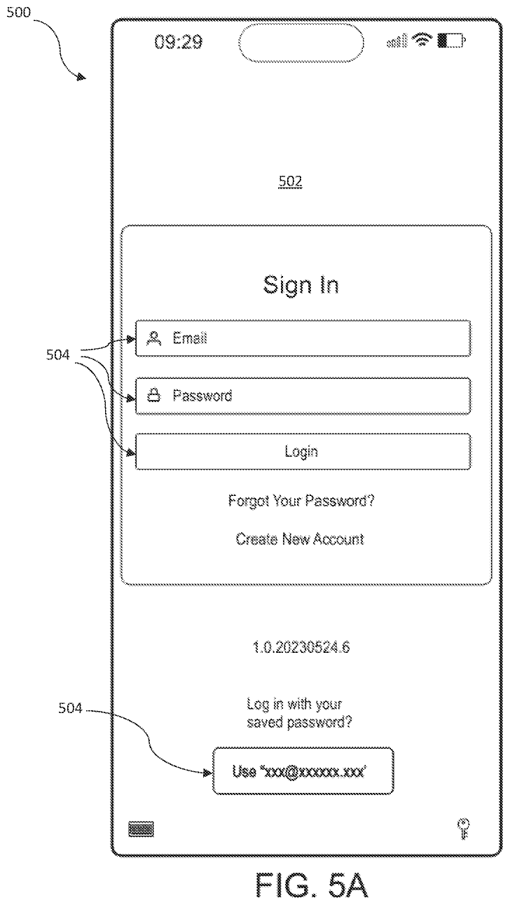

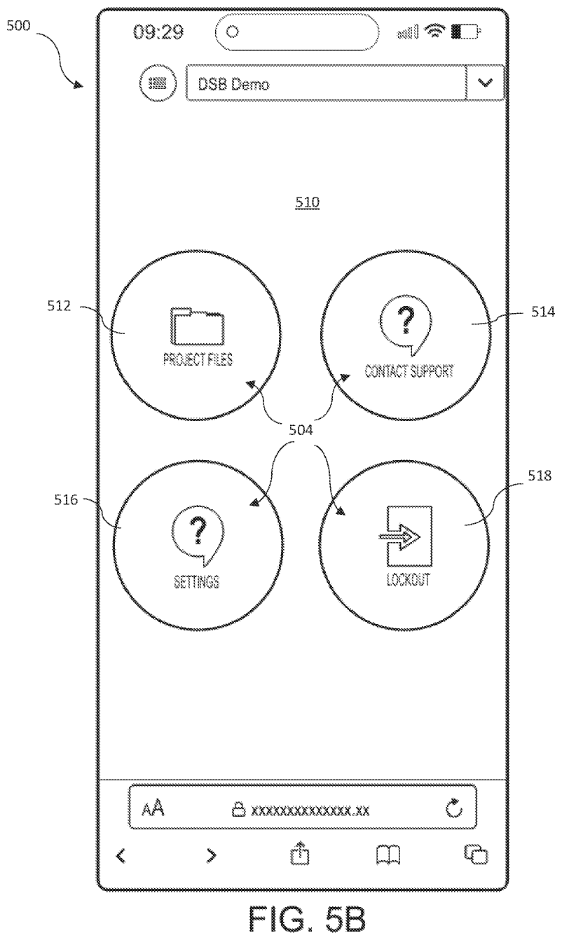

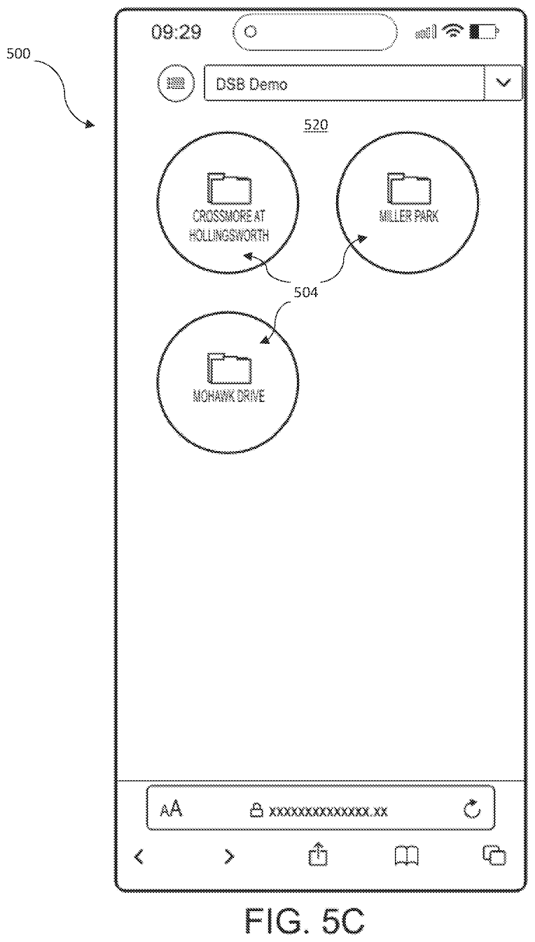

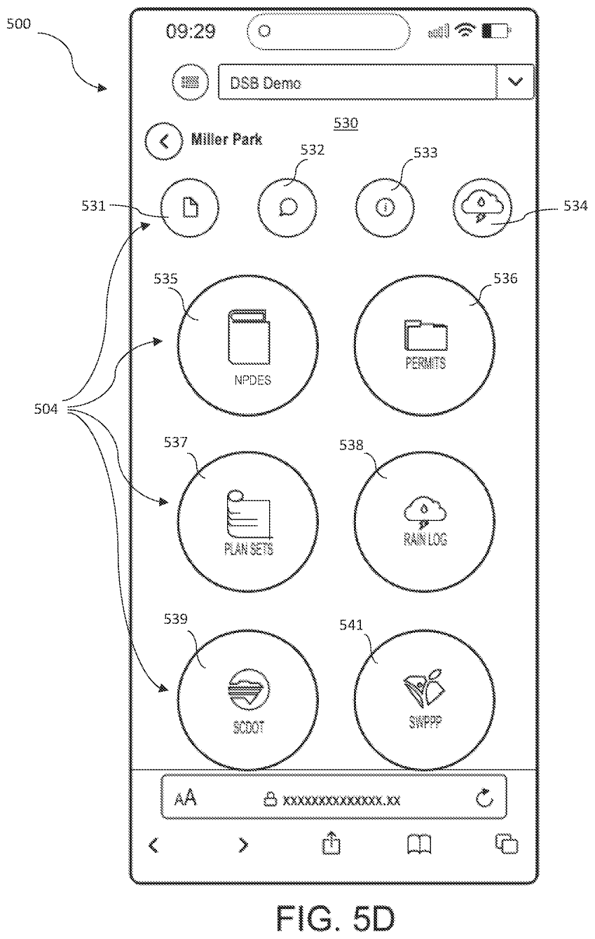

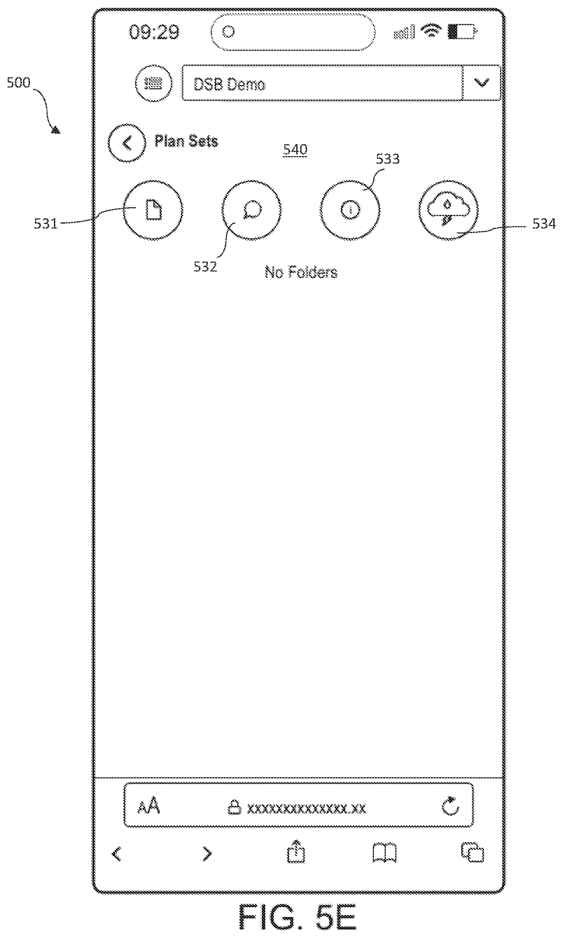

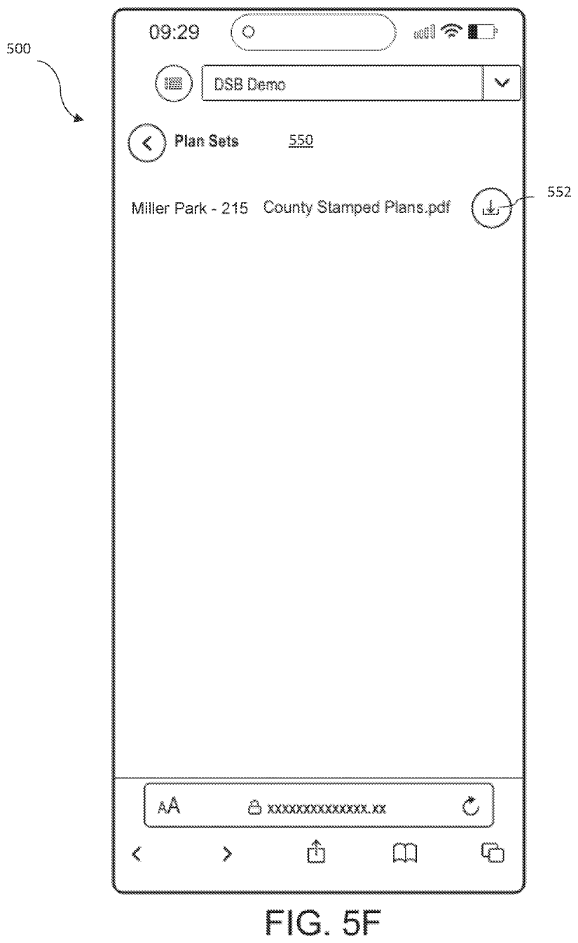

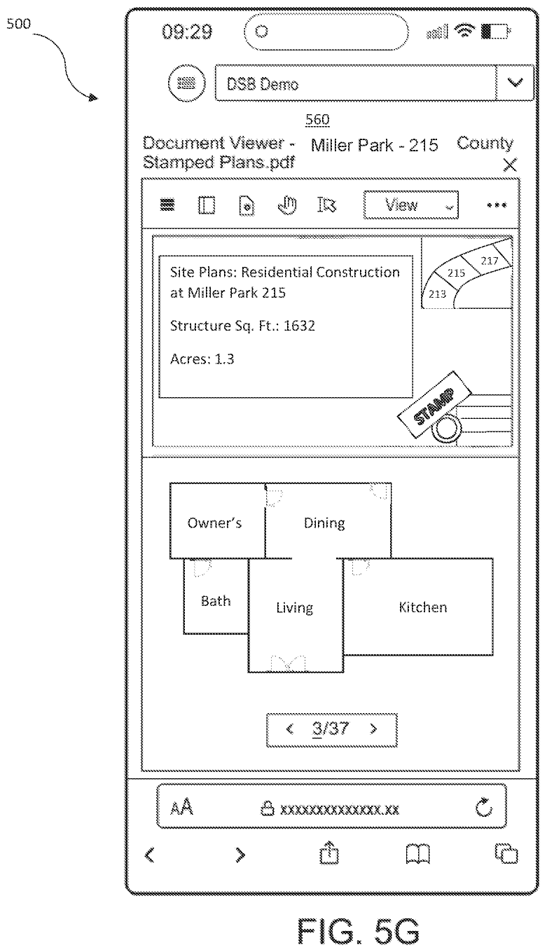

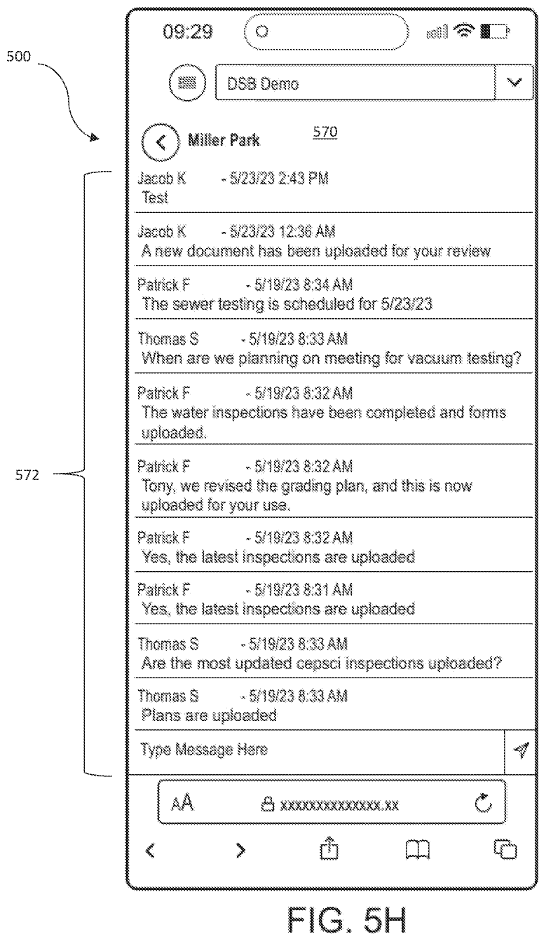

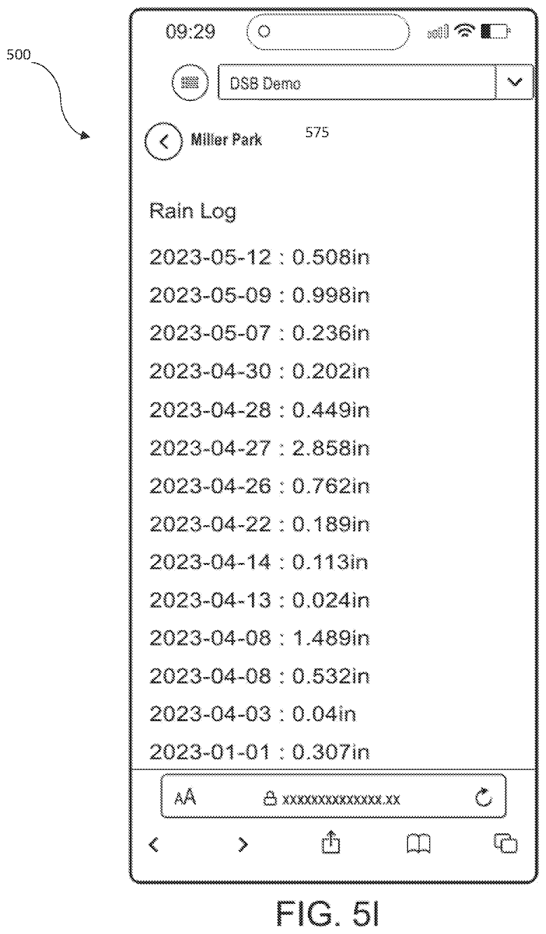

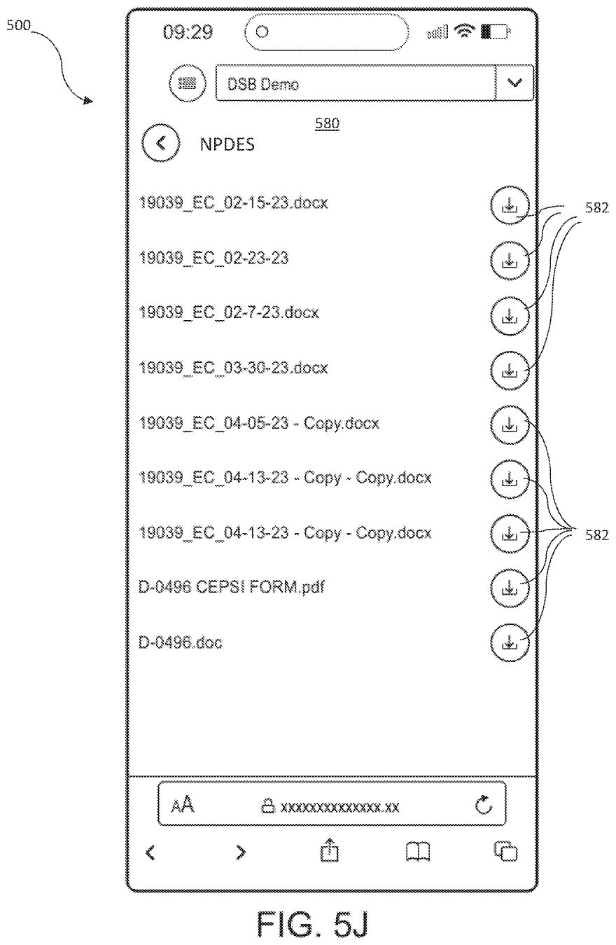

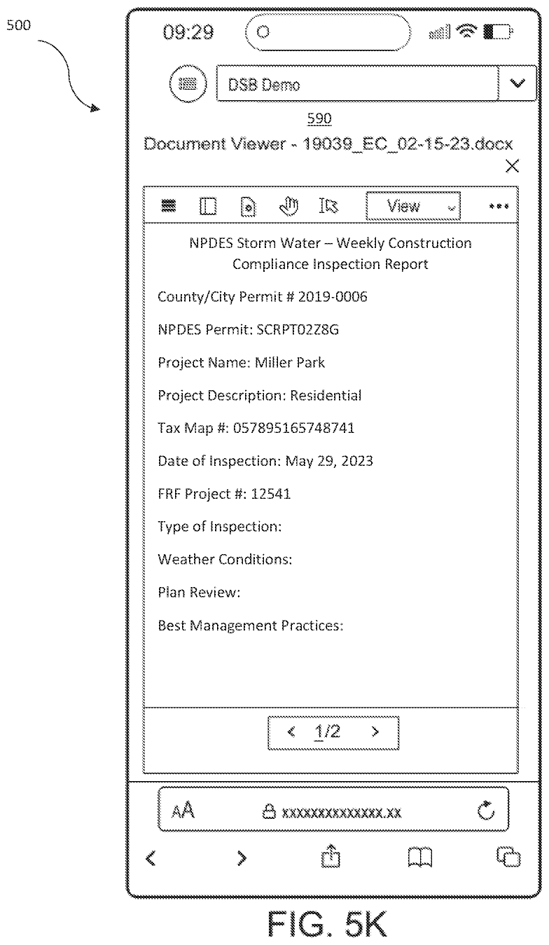

FIG. 5A depicts an example webpage configured to receive authentication credentials, in accordance with an embodiment of the present invention;

FIG. 5B depicts an example landing page accessible based on the user providing authentication credentials, in accordance with an embodiment of the present invention;

FIG. 5C depicts an example interface accessible based on the user selecting a project files icon, in accordance with an embodiment of the present invention;

FIG. 5D depicts an example interface accessible based on the user selecting a construction site from the control inputs depicted in FIG. 5C, in accordance with an embodiment of the present invention;

FIG. 5E depicts an example interface accessible based on the user selecting an icon to access plan sets for the construction site, in accordance with an embodiment of the present invention;

FIG. 5F depicts an example interface accessible based on the user selecting an icon to access documents, in accordance with an embodiment of the present invention;

FIG. 5G depicts an example interface accessible based on the user downloading a document, in accordance with an embodiment of the present invention;

FIG. 5H depicts an example comments functionality where users may submit comments associated with activities at a construction site, in accordance with an embodiment of the present invention;

FIG. 5I depicts an example rain log functionality that provides a history of precipitation at the construction site, in accordance with an embodiment of the present invention;

FIG. 5J depicts an example NPDES section that permits users to download copies of permits associated with the construction site, in accordance with an embodiment of the present invention;

FIG. 5K depicts an example downloaded NPDES inspection report associated with the construction site, in accordance with an embodiment of the present invention;

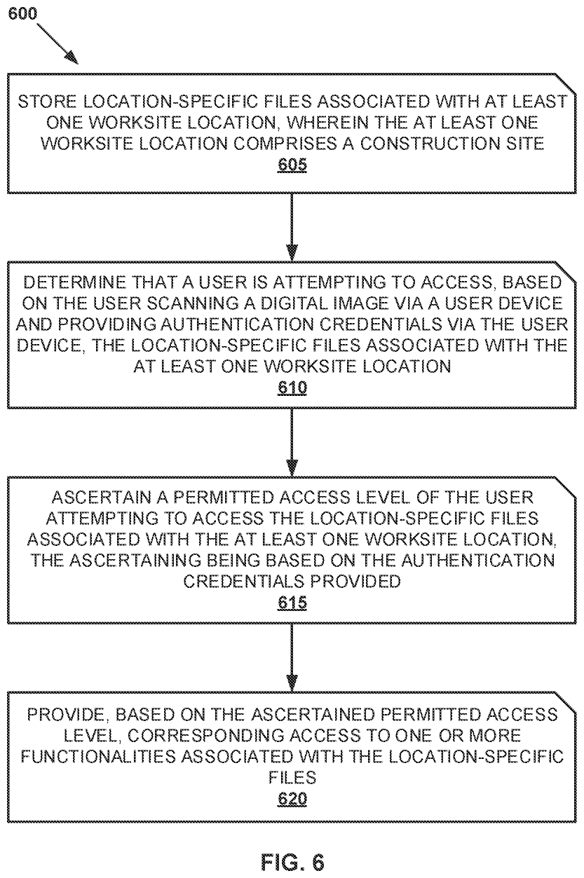

FIG. 6 depicts a block diagram of an example method for permission-based cloud storage and file sharing, in accordance with an embodiment of the present invention; and

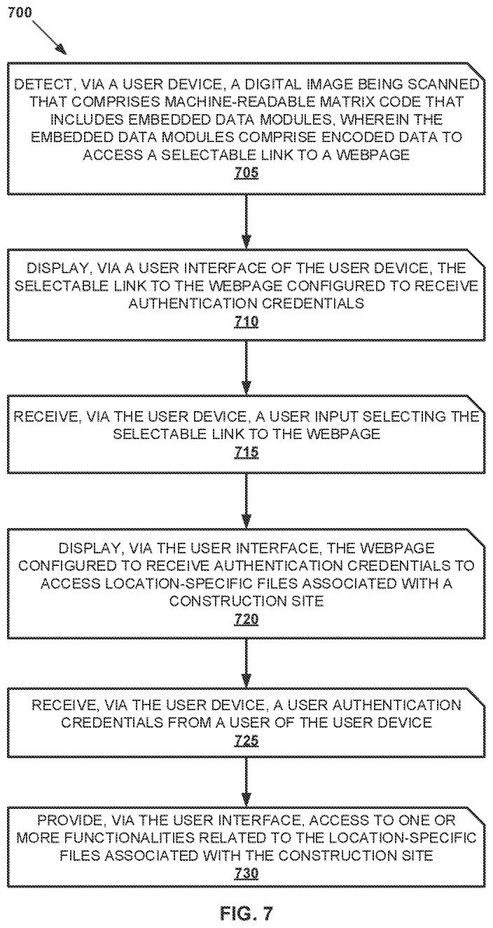

FIG. 7 depicts a block diagram of an example method for permission-based cloud storage and file sharing, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to avoid obscuring the invention with well-known details. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “couple,” “coupled.” “couples,” “coupling,” “fixed.” “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

As used herein, the term “provider” generally describes a person or business enterprise that hosts, maintains, otherwise provides, and/or uses computer systems that provide functionality for the disclosed systems and methods. In particular, the term “provider” may generally describe a person or business enterprise providing goods or services accessible via one or more user devices. Interactions between a provider system and a user device may utilize a communicative interaction between a computing system of the provider, and a user device of a user. For instance, user(s) may provide various inputs to a user device that can be interpreted and analyzed using processing systems of the user device and/or processing systems of the provider system. Further, the provider system and the user device may be in communication via a network. According to various embodiments, the provider system and/or user device(s) may also be in communication with external or third party devices (e.g., a third-party server) of a third-party system that may be used to perform one or more computing operations. In some embodiments, the functions of one illustrated system or server may be provided by multiple systems, servers, or computing devices, including those physically located at a central computer processing facility and/or those physically located at remote locations.

Embodiments of the present invention are described herein, with reference to flowchart illustrations and/or block diagrams of computer-implemented methods and computing systems according to embodiments of the invention. Each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus or apparatuses (the term “apparatus” includes systems and computer program products). In particular, the computer readable program instructions, which be executed via the processor of the computer or other programmable data processing apparatus, create a means for implementing the functions/acts specified in the flowchart and/or block diagram block or blocks.

In one embodiment, these computer readable program instructions may also be stored in one or more computer-readable storage media that can direct a computer or other programmable data processing apparatus, and/or other devices, to function in a particular manger, such that a computer readable storage medium of the one or more computer-readable storage media having instructions stored therein comprises an article of manufacture including instructions which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block or blocks. Example computer readable storage media may include, but not be limited to, any electronic storage device, a magnetic storage device, an optical storage device, an electromagnetic storage device, a semiconductor storage device, or any suitable combination of the foregoing. A non-exhaustive list of example computer readable storage media include a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a microdrive, a mechanically encoded device such as punch-cards or raised structures in a groove having instructions recorded thereon, and any suitable combination of the foregoing. Computer readable storage media, as used herein, may be used for long-term, intermediate-term, and/or short-term storage of computer-readable instructions, but is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In another embodiment, these computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

Example computer program instructions may include assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language (e.g., Java, Ruby, Python, C#, hypertext preprocessor (PHP), C++, or the like, and procedural programming languages, such as FORTRAN, BASIC, the “C” programming language, or similar programming languages.

The computer program instructions, whether stored in the computer-readable storage medium and/or computer-readable memory may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable instructions for implementing the specified logical function(s). Additionally, the alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, or the functions of the blocks may sometimes be executed in the reverse order, depending upon the functionality involved.

FIG. 1 depicts an example computer system 100 configured to perform various processes described herein, according to an embodiment of the present invention. The example computer system may be incorporated into a user device that includes, for example, a laptop, a computer, a tablet, a mobile computing device such as a smart phone, a portable digital assistant, a pager, a television, a gaming device, an audio/video player, a virtual assistant device, an internet-of-things device, a smart home device, a wireless personal response device, any combination of the aforementioned, and/or any other electronic device with processing and communication capabilities. The computer system 100 is in communication with one or more external device(s) 150, which may include, for example, devices (e.g., server(s)) of a provider system. The computer system 100 includes one or more central processing unit(s) 102 (CPU) that includes one or more processor(s) 104. The CPU(s) 102 and/or additional processor(s) 104 include functional components used in the execution of instructions and/or otherwise may be configured to perform a computer-implemented method by executing instructions. For example, the CPU(s) 102 and/or additional processor(s) 104 may include functional components to fetch program instructions from one or more locations such as the memory 106, which may include a cache or main memory. The CPU(s) 102 and/or additional processor(s) 104 may decode the program instructions and execute the program instructions, which may or may not require accessing the memory 106 as part of the instruction execution. Further, the CPU(s) 102 and/or additional processor(s) 104 may write results of the executed instructions to, for example, a destination register for storing the result of the execution, or various other locations for further processing and/or storage. The CPU 102 may include a control unit 108 that directs the operation of the processor(s) 104 and may include, for example, a binary decoder to convert coded instructions into timing and control signals that direct the operation of various other components (e.g., memory 106) of the computer system 100.

Processor(s) 104 may include circuitry for implementing communication and/or logic functions of the computer system 100. The processor(s) 104 may include a digital signal processor, a microprocessor, a graphics processing unit (GPU), a microcontroller, an application-specific integrated circuit (ASIC), a programmable logic device (PLD), digital signal processor (DSP), a field programmable gate array (FPGA), programmable logic arrays (PLA) a state machine, a controller, gated or transistor logic, discrete physical hardware components, various analog to digital converters, digital to analog converters, and/or other support circuits and/or combinations thereof. According to various embodiments, the processor(s) 104 may also include register(s) 110 that configured as a small amount of fast storage and may be used and/or otherwise accessed by one or more of the functional components for various operations (e.g., arithmetic operations, bitwise operations, etc.). The processor(s) 104 may also utilize a combinational logic system 112 to perform various calculations (e.g., using Boolean algebra) on input signals and stored data to produce specified outputs from such inputs. Control and signal processing functions of the computer system 100 are allocated between these processor(s) 104 according to their respective capabilities based on the functionality used to encode and interleave messages and data prior to modulation and transmission thereof. Processor(s) 104 may include an internal data modem and other functionality to operate software programs (e.g., computer programs 116). In one non-limiting example, the processor(s) 104 may be capable of operating a connectivity program, such as a web browser application, that may then allow the computer system 100 to transmit and receive (e.g., to one or more external device(s) 150) content such as, for example, web content, location-based content, etc. in accordance with a Wireless Application Protocol (WAP), Hypertext Transfer Protocol (HTTP), and/or the like.

The memory 106 may be operatively coupled to the processor(s) 104 and can be or include main or system memory (e.g. RAM), non-volatile memory, volatile memory, or any computer readable storage media used to store data, code or other information that the processor(s) 104 use in the execution of program instructions. Memory 106 can include storage device(s) such as hard drive(s), flash media, optical media, and/or cache memory that may be embedded and/or removable, as examples. Memory 106 can include, for instance, a cache, such as a shared cache, which may be coupled to local caches (examples include L1 cache, L2 cache, etc.) of processor(s) 104. In various embodiments, the memory 106 includes any tangible device that can retain and store instructions for use ban an instruction execution device (e.g., processor(s) 104). The memory 106 can store any number of pieces of information and data used by the computer system 100 to implement functions described herein as well as other functions not expressly described.

Additionally, memory 106 may be or include at least one computer program product having a set (e.g., at least one) of program modules, instructions, code or the like that is/are configured to carry out functions of embodiments described herein when executed by the processor(s) 104. Memory 106 can store an operating system 114, other computer programs 116, such as one or more computer programs/applications that execute to perform aspects described herein, and/or various other data items. Specifically, programs/applications can include computer readable program instructions and code that may be configured to carry out functions of embodiments of aspects described herein, and can also include cashed data, user files, audio files, video recordings, files downloaded or received from other devices, and/or other data items required or related to any or all of the programs/applications. Example programs/applications can include integrated software applications that manage device resources, generate user interfaces, accept user inputs, and facilitate communications with other devices among other functions. The integrated software applications can include an operating system, such as Linux®, UNIX®, Windows®, macOS®, iOS®, Android®, or other operating system compatible with personal computing devices. Programs/applications can also include applications (e.g., a mobile application) considered web-browser applications that typically provide a graphical user interface (GUI) that can be displayed (e.g., via a user interface) and may include features for accepting inputs from users (e.g., via control inputs such as text boxes, data fields, hyperlinks, pull down menus, check boxes, and the like).

Computer system 100 may also include input/output (I/O) interfaces 118 through which external device(s) 150 are connected. Example external device(s) 150 in some examples may include an external sever, workstation, set of servers, cloud-based application or system, etc. located outside of the user computer system 100 that the computer system 100 may access via the Internet. In some examples, external device(s) 150 may additionally or alternatively include electrical components included within the user device itself. Specifically, an I/O device may be incorporated into the computer system 100 itself or the I/O device may be regarded as an external device 150 coupled to the computer system 100 through one or more I/O interfaces 118.

External device(s) 150 can include, but are not limited to, printers, display monitors, microphone(s), speaker(s), Global Positioning System (GPS) devices, camera(s) (e.g., digital cameras), lights, non-transitory storage media (e.g., ROM), accelerometers, gyroscopes, magnetometers, sensor devices configured to sense light, proximity, heart rate, body and/or ambient temperature, blood pressure, and/or skin resistance, activity monitors, a keyboard, a pointing device, a joystick, a button, soft key, infrared sensor, a display screen (e.g., a liquid crystal display (LCD), light emitting diode (LED) display, or the like), a sensitive input screen (e.g., a touch screen or the like), and/or any other devices that enable a user to interact with computer system 100, any device that enables computer system 100 to communicate with one or more other computing systems or peripheral devices, one or more data storage devices, which may store one or more programs, one or more computer readable program instructions, and/or data, etc., removable/non-removable storage media, volatile/non-volatile computer system storage media, a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media, non-volatile magnetic media (typically called a “hard drive”), and/or any other suitable devices adapted to provide an input or output to the computer system 100 and/or commonly used with any suitable operating system on personal computers, central computing systems, phones, and/or similar devices.

I/O interfaces 118 may provide communication (e.g., two-way communication and data exchanges). Example I/O interfaces 118 may additionally or alternatively include, for example, a network interface/adapter that enables the computer system 100 to communicate with one or more networks, such as a local area network (LAN), a general wide area network (WAN), and/or a public network (e.g., the Internet), and/or provide communication with other computing devices or systems, storage devices, or the like. Specific examples of I/O interfaces 118 may also include Ethernet-based (such as Wi-Fi) interfaces, near-field communication devices, transceivers, and/or Bluetooth® adapters. (BLUETOOTH is a registered trademark of Bluetooth SIG, Inc., Kirkland, Washington, U.S.A.). The I/O interfaces 118 may, in some embodiments, be configured as a means for providing user inputs via virtual buttons, selectable options, a virtual keyboard, a touch screen, a touchpad, and other indicia that, when touched, can be used by the user to control the computer system 100. The I/O interfaces 118 may include and/or be operatively connected to circuitry used to convert analog signals and/or other signals into digital data, and/or may be configured to convert digital data to another type of signal. For example, the I/O interfaces 118 may receive and convert physical contact inputs, physical movements, auditory signals, etc. to digital data. Once converted, the digital data may be provided to the processor(s) 104 for processing.

The I/O interfaces 118 may be coupled to processor(s) 104, external device(s), and each other via one or more buses, circuitry, intraconnections, and/or other connections that facilitate communication. Bus connections represent one or more of any of several types of bus structures, including a memory bus or memory controller, a peripheral bus, an accelerated graphics port, a high-speed interface, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI). The bus connections may operatively couple and/or electrically connect various components of the computer system 100 with one another directly or indirectly by way of intermediate components.

The communication between I/O interfaces 118 and external devices 150 can occur across wired and/or wireless communications link(s) 120, such as Ethernet-based wired, universal serial bus (USB) wired or wireless connections. Example wireless connections include cellular, Wi-Fi, Bluetooth®, proximity-based, near field, or other types of wireless connections. More generally, communications link(s) 120 may be any appropriate wireless and/or wired communication link(s) 120 for communicating data. In some instances, the communications link(s) may utilize various modes and/or protocols, including, as non-limiting examples, global system for mobile (GSM) voice communication, short message service (SMS), enterprise messaging service (EMS), multimedia messaging service (MMS) messaging, second-generation (2G) wireless communication protocols IS-95 such as code division multiple access (CDMA), IS-136 such as time division multiple access (TDMA), personal digital cellular (PDC), or general packet radio service (GPRS), third-generation (3G) wireless communication protocols, such as Universal Mobile Telecommunications System (UMTS), CDMA2000, wideband CDMA (WCDMA) and/or time division-synchronous CDMA (TD-SCDMA), fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like.

Specific example I/O interfaces 118 that may be used to perform the processes disclosed herein may incorporate and or otherwise be configured to capture an image (e.g., via camera(s) and/or other optical instrument(s)). The I/O interfaces 118 may include one or more lenses and one or more image sensors (e.g., a charge coupled device (CCD) sensor) configured to convert photons into an electrical signal. For example, pixels of each the image sensors may each include a photodiode (e.g., a semiconductor) that becomes electrically charged in accordance with the strength of the light that strikes the photodiode, where the electrical charge is then relayed to be converted to an electrical signal. In one embodiment, a series of pulses may be applied to the one or more image sensors to relay the accumulate charges within each photodiode in succession down a row of photodiodes to an edge of the respective image sensor. Other optical instrument functionalities are also contemplated herein.

In various embodiments, the I/O interfaces 118 may be configured to obtain and/or process various forms of authentication by obtaining authentication information from a user of a user device accessing or that otherwise incorporates the computer system 100. The authentication information may be provided, for example, to access specific information that is restricted to authorized users. In one example, a restricted web portal may require login credentials from the user in order to provide the user with access to the web portal and perform various functionalities therethrough. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems. For instance, in some cases, in order to authenticate a user, the user may be required to provide multi-factor authentication by requiring more than one authentication method.

In various embodiments, the I/O interfaces 118 may include a positioning device and/or otherwise be configured to identify a geographic location of a user device using a positioning system. For example, the I/O interfaces 118 may include a GPS transceiver, an antenna, transmitter, and/or receiver that can be used, via triangulation of cellular signals, to identify an approximate location of a user device.

In some embodiments, particular portions or steps of methods and functions described herein are performed in whole or in part by way of the CPU 102, processor(s) 104, and/or cloud-based computing devices/systems such that the computer system 100 facilitates operations that may only partially be performed locally and may incorporate communication, data transfer, and/or user inputs and outputs.

According to various embodiments, the user of the computer system 100 can be any individual, a group, entity, etc. that is in possession of or has access to a user device which may be personal or public devices used to access the computer system 100. The user can provide inputs to the computer system 100 through, for example, user-side actions including voice, text, movement, and/or graphical indicia selections

Computer system 100 may be operational with numerous other general purpose or special purpose computing system environments or configurations. Computer system 100 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like. The computer system 100 may also be referred to herein as a data processing device/system, computing device/system/node, or simply a computer. The computer system 100 may be based on one or more of various system architectures and/or instruction set architectures.

FIG. 2 depicts an example cloud-computing environment 200, according to an embodiment of the present invention. The cloud-computing environment 200 may be provided by a “provider” and include a network 260 that is communicatively connected, via wireless and/or wired connections to various network devices that may be local and/or remote to one another. Example network devices may include the user devices, such as laptop 262, tablet 264, smart phone 266, and desktop 268, as well as various other computing devices, mobile devices, and/or servers. As depicted, the network 260 can be a large distributed network that includes multiple servers (e.g., file servers, catalog servers, computing servers, application servers, etc.), databases, storage locations, and/or computers. The network 260 may facilitate sharing data and/or resources across distributed locations. Although singly depicted with one network 260 for illustrative convenience, the cloud-computing environment 200 may include more than one network without departing from the scope of this description. In some embodiments, the network 260 may be or include a secured network. In some embodiments, the network 260 may be implemented, at least in part, through one or more connections to the Internet. In some embodiments, a portion of the network 260 may include a virtual private network (VPN) or an Intranet.

The cloud-computing environment 200 may also include wired and wireless links, including, as non-limiting examples, 802.11a/b/g/n/ac. 802.20, WiMAX, LTE, and/or any other wireless link. The network 260 may include any internal or external network, networks, sub-network, and combinations of such operable to implement communications between various computing components within and beyond the illustrated cloud-computing environment 200. The network 260 may communicate, for example, Internet Protocol (IP) packets, frames using frame relay, voice, video, data, and other suitable information between network addresses. The network 260 may also include one or more local area networks (LANs), radio access networks (RANs), metropolitan area networks (MANs), wide area networks (WANs), personal area networks (PANs), WLANs, campus area network (CAN), storage-area network (SAN), all or a portion of the internet and/or any other communication system or systems at one or more locations.

The network 260 may incorporate various cloud-based deployment models including, for example, private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public that remain unique entities but are bound together by standardized or proprietary technology that enables data and application portability (e.g., load-balancing between cloud networks).

At least some of the network devices, such as the user devices (e.g., laptop 262, tablet 264, smart phone 266, and desktop 268) may include a computer system, such as the computer system 100 of FIG. 1. The network 260 may also include any number of data sources, user devices, consumers, customers, third-party devices, external databases, servers, etc. from any number of users (e.g., individual persons, institutions, companies, organizational entities, groups, etc.). In some embodiments, the network 260 incorporates any number of virtual resources, such as cloud resources or virtual machines. Virtual resources may utilize a cloud-computing configuration to provide an infrastructure that includes a network of interconnected nodes and provides stateless, low coupling, modularity and semantic interoperability. Such interconnected nodes may incorporate a computer system that includes one or more processors, a memory, and a bus that couples various system components (e.g., the memory) to the processor, and may be grouped physically or virtually in one or more networks. It should be understood that such interconnected nodes may include the types of computing devices and systems depicted, as an example, in FIG. 1, which is intended to be illustrative only, and such interconnected nodes can communicate with any type of computerized device across the network 260. Such virtual resources may be available for shared use among multiple distinct resource consumers and in certain implementations, virtual resources do not necessarily correspond to one or more specific pieces of hardware, but rather to a collection of pieces of hardware operatively coupled within a cloud-computing configuration so that the resources may be shared as needed.

Cloud computing utilized by the cloud-computing environment 200 is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Processes described herein may be performed singly or collectively by one or more computer systems (e.g., such as computer system 100) that are accessible via the network 260. It is to be understood that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

The network 260 of the cloud-computing environment 200 may be configured to be accessed by a network device (e.g., laptop 262, tablet 264, smart phone 266, and desktop 268) to provision computing capabilities, such as server time and network storage, as needed without requiring human interaction with the provider. Further, the network 260 may be accessed through standard computer systems (e.g., via I/O interfaces 118 of computer system 100) used by thin or thick client platforms (e.g., mobile phones, laptops, PDAs, etc.). Further, the network 260 may pool computing resources to serve multiple network devices using, for example, a multi-tenant model with various physical and virtual resources assigned in accordance with demand. For instance, physical and/or virtual resources accessed via the network 260 may be dynamically assigned and reassigned to different end-users such that the end-user has no control or knowledge of the exact location of the provider resources accessed via the network 260, although general abstraction may be used to identify a datacenter location, city, state, country, etc. The network 260 may also be scaled and provisioned, sometimes automatically, rapidly and elastically based on various functionality requirements and/or usages. In some instances, the network resources available via the network 260 may be regulated based on a metering capability (e.g., based on storage, processing, bandwidth, active user accounts, etc.).

FIG. 3 depicts an example of cloud computing services, according to an embodiment of the present invention. The cloud computing services may be utilized by a cloud computing environment (e.g., cloud-computing environment 200) and may include a Software-as-a-Service (SaaS) 370, a Platform as a Service (PaaS) 380, and/or an Infrastructure as a Service (IaaS) 390. The cloud computing services offer infrastructure, platforms, and/or applications/software as services to and end-user so that the end-user does not need to maintain resources on a local computing device.

The SaaS service 370 may provider an end-user with the ability to use the provider's applications that are accessible and operable via cloud infrastructure. Specifically, the provider's applications layer 372 may be accessible via various network devices that include computer systems (e.g., computer system 100) via, for example, a thin client interface such as a web browser. With the SaaS model, the end-user is not authorized to manage or control the underlying cloud infrastructure, network, servers, operating systems, storage, or individual application capabilities offered by the provider, with the exception of limited user-specific application configuration settings.

The PaaS service 380 may provide the end-user with the ability to deploy consumer-created or acquired applications onto the cloud infrastructure using a platform layer 382, where the consumer-created applications may be created using programming languages and tools supported by the provider. Specifically, the end-user is not authorized to manage or control the underlying cloud infrastructure including networks, servers, operating systems, or storage. However, the end-user is authorized to control the deployed applications and possibly application hosting environment configurations available via the platform layer 382.

The IaaS 390 service may provide the end-user with the ability to provision processing, storage, networks, and other fundamental computing resources. The IaaS service includes a hardware layer 392 that is responsible for managing the physical resources available via the cloud-computing environment (e.g., cloud-computing environment 200). Specifically, the hardware layer 392 may include physical servers, routers, switches, power and cooling systems and may, according to one embodiment, be implemented using one or more data centers that incorporate many (e.g., hundreds, thousands, etc.) of interconnected servers, CPUs, mainframes, reduced instruction set computer (RISC), architecture based servers, blade servers, storage devices, network computing components, memory, disk, bandwidth, etc. organized through switches, routers, and/or other fabrics.

IaaS service 390 may also include an infrastructure layer (e.g., a virtualization layer) 394 that includes virtual machine capabilities and storage capabilities using computing resources that may be partitioned using various virtualization technologies (e.g., a hypervisor that runs directly on the system hardware (e.g., Xen), a kernel-based virtual machine (KVM), Hyper-V virtualization, VMware software, etc.). With IaaS service 390, the end-user may be able to deploy and run arbitrary software, which can include operating systems and applications, via the virtual machines. Although the end-user would not be authorized to manage or control the underlying cloud infrastructure, the end-user would be authorized to control operating systems, storage, deployed applications, and some limited network components (e.g., host firewalls).

Although various embodiments are described above, these are only examples. For example, computing environments of other architectures can be used to incorporate and use one or more embodiments.

Advantageously, the disclosed environments, systems, and method address the shortcomings associated with having physical documentation and job boxes at a worksite. In particular, disclosed herein is a cloud-based software solution that incorporates a cloud-computing environment (e.g., cloud-computing environment 200) that digitizes analog site boxes on construction sites, thereby eliminating the need to have a physical analog site box. The cloud-based software provides easy and fast access to important documents, can ameliorate communication, and improve collaboration among team members of a construction project. Further, the cloud-based software increases productivity by eliminating the need to continually replace documents at a worksite and physically travel to worksites in order to perform compliance checks to ensure the appropriate documentation is accessible at the worksite. Individuals that visit the worksite and scan, using their user device, a digital image, such as a QR code, which is posted at the worksite, may access the cloud-based software. The user device used by individuals may incorporate a computer system such as computer system 100 described herein with reference to FIG. 1. Once the individual scans the QR code, the individual can select a link to a uniform resource locator (URL) to access a webpage where the user can input authentication credentials and/or create a user account to access digital copies of the documentation. The QR codes may be location-specific so that the end-user attempting to access the documentation only has access to documents that are specific to that worksite.

Depending on whether the individual is a subscription-paying member or is associated with a subscription account will determine the permitted access level of the user account. User accounts that are associated with a paid subscription may have access to more functionalities on the cloud-based software than user accounts that are not associated with a paid subscription. For example, if a user account is not associated with a paid subscription, the user may only be able to view documents accessible via the cloud-based software, whereas user accounts associated with a paid subscription may have access to upload, edit, download, or otherwise manipulate files via the cloud-based software. In some embodiments, a subscription account may have multiple subscribers/users that each have different authorizations as defined by the primary account/subscription holder.

Another advantage available to users is the ability to remotely access copies of documentation. For instance, in order to perform a compliance check of the copies of documents that are accessible at a worksite in accordance with state or municipal regulations, a user (e.g., such as a municipal inspector) merely needs to be able to scan the digital image that is specific to that construction site. For example, a user may copy or download the QR code so that it can be digitally scanned at a remote location that has Internet accessibility. Once the user provides authentication information and logs in to the site, the user can easily electronically view copies of all documentation that would be accessible at the construction site. Further, if the user is a paid subscriber, the user can remotely upload documentation that may not be saved in order to comply with the regulations. In addition, users may want to remotely download copies of specific documents, which can be easily accomplished by accessing documentation stored via the cloud-based software.

Another advantage provided via the cloud-based software is that it provides a way to automatically monitor, track, and store a precipitation log of the worksite. Often some projects have rain gauges physically at the worksite that are used to track rain levels at the worksite. In some cases, depending on the state and/or municipality, regulations may require construction companies to track rain levels at the worksite. The disclosed cloud-based software provides a precipitation log that gathers data based on weather radar for the specific latitude and longitude of the worksite. Specifically, the precipitation log may provide various rain-related tracking functionalities including calendaring, water accumulations, and histories.

Another advantageous functionality provided by the cloud-based software is that it provides automatic electronic notifications (e.g., push notification, email, SMS text message, etc.) of events associated with a subscriber account and/or a specific worksite. For instance, users associated with an account for a local municipality may receive a daily electronic notification of all documents or files that are uploaded, downloaded, edited, and/or viewed. Advantageously, this will give the local municipality visibility into whether the appropriate and/or required permits or other documents are accessible at a given worksite and/or for all worksites within that municipality. Similarly, a worksite engineer, general contractor, etc. may be notified when such documents or files are uploaded, downloaded, edited, and/or viewed for each worksite and/or worksites within an administrative division. For instance, with a residential development, the individual overseeing construction of all residential units at the residential development may receive notifications for each residential unit within that development. According to one embodiment, end-users and/or primary account/subscription holders may define notification preferences for specific worksites and/or regions. In one embodiment, the electronic notifications may be provided as batched notifications in a daily, weekly, monthly, etc. notification, whereas in another embodiment the electronic notifications may be provided in real-time based on a user's notification preferences.

FIG. 4 depicts an example digital image 400 displayed at a construction site 450, in accordance with an embodiment of the present invention. The digital image 400 may be displayed at the construction site 450 using a physically posted sign 402. For instance, the sign 402 may be posted on a post 404, the side of a structure (e.g., a construction trailer), easel stand, or various other locations at the construction site 450. Each digital image 400 posted at the construction site 450 is site-specific so that the digital image 400 is specific to the construction project at the construction site 450. When the digital image 400 is scanned, a link is displayed via a user interface of the user's electronic device. According to one embodiment, the user selects the link to access documentation that would be associated with that digital image 400 and a webpage that is configured to receive authentication information, such as the example webpage of FIG. 5A, is displayed.

FIG. 5A depicts an example webpage 502 accessible by a user device 500 that is configured to receive authentication credentials, in accordance with an embodiment of the present invention. The example embodiment depicted provides control inputs 504 for providing an email and password to login and provides a means for creating a new account and retrieving a forgotten password. However, the webpage 502 could be configured differently in other embodiments such that the authentication information that could be entered may include a username, a password, biometric information (e.g., using facial recognition) a fingerprint, personally identifiable information, and/or various other authentication credentials. In some instances, the user device

FIG. 5B depicts an example landing page 510 accessible via the user device 500 of FIG. 5A based on the user providing authentication credentials, in accordance with an embodiment of the present invention. The landing page 510 may be configured as a home screen from which the user can access various control inputs 504. Specifically, example control inputs 504 (e.g., selectable buttons) can include a project files input 512 to access documentation for a construction project, a contact support input 514 that when selected enables the user to receive technical or informational support. A settings input 516 is also included, which enables the user to modify various user settings, and a logout input 518 is also depicted, which enables the user to sign out of their user account.

FIG. 5C depicts an example interface 520 of a user device 500 of FIG. 5A that is accessible based on the user selecting a project files icon (i.e., the project files input 512), in accordance with an embodiment of the present invention. The interface 520 may include various additional control inputs 504 for to access documents for specific locations. If the digital image (e.g., digital image 400) that was scanned is for a specific construction site, then an icon for that specific construction site will be available. In other embodiments, when users have a permitted access level that enables them to access documentation for multiple sites, then multiple icons may be displayed, as is depicted in this example embodiment. In addition, a timestamp may be provided for all and/or certain events associated with a worksite and/or subscription account. For instance, when a user utilizes control inputs, such as control inputs 504 to access, view, upload, download, edit, or otherwise perform various functionalities, the cloud-based software may provide a timestamp (e.g., indicating date and/or time) of such activity. Further, according to various embodiments, certain users (e.g., primary account/subscription holders) may be notified of such activity via electronic notification.

FIG. 5D depicts an example interface 530 of the user device 500 of FIG. 5A that is accessible based on the user selecting a construction site from the control inputs 504 depicted in FIG. 5C, in accordance with an embodiment of the present invention. The control inputs 504 may include, according to various examples, a new document input 531, a comment input 532, an information input 533, log input 534, national pollutant discharge elimination system (NPDES) input, a permits input 536, a plan sets input 537, a rain log input 538, a transportation input 539, and a stormwater pollution prevention plan (SWPPP) input 541.

FIG. 5E depicts an example interface 540 of the user device 500 of FIG. 5A that is accessible based on the user selecting an icon to access plan sets (e.g., plan sets input 537 of FIG. 5D) for the construction site, in accordance with an embodiment of the present invention. The interface 540 may list folders for various plans, if permitted based on the user's permitted access level. The control inputs 504 may also display the new document input 531, a comment input 532, an information input 533, and log input 534 as depicted in FIG. 5D. FIG. 5F depicts an example interface 550 of the user device 500 of FIG. 5A that is accessible based on the user selecting an icon to access documents, such as the plan sets input 537 of FIG. 5D, in accordance with an embodiment of the present invention. The plan sets for a specific construction site may be downloadable based on selecting a download input 552.

FIG. 5G depicts an example interface 560 of the user device 500 of FIG. 5A that is accessible based on the user downloading a document via the download input 552 of FIG. 5F, in accordance with an embodiment of the present invention. The interface 560 may be configured as a document view that depicts site plans or various other documents for a construction site such as worksite permits, site plans, worksite compliance reports, worksite inspection reports, architectural drawings, schedules, work orders, safety reports, certificates of insurance, worksite specifications, project diaries, requests for information, contracts, purchase orders, change orders, worksite drawings, progress reports, work orders, a works diary, works passing records, test results, supply registers, sample records, measurement books, attendance records, concrete pouring requests, non-conformance reports, and bills records. In some embodiments, subscribers and/or users may be notified (e.g., via an electronic notification) that a document has been downloaded. Further, the cloud-based software may provide a timestamp (e.g., indicating a date and time) when that document was downloaded.

FIG. 5H depicts an example comments functionality 570 interface of the user device 500 of FIG. 5A where users may submit comments 572 associated with activities at a construction site, in accordance with an embodiment of the present invention. Such comments may facilitate communication between team members (e.g., contractors, subcontractors, etc.) for a construction project. In some embodiments, the comments may provide automatic notifications that certain documents are uploaded to the cloud storage. According to one embodiment, the comments functionality 570 may be accessed when the user selects the comment input 532 of FIG. 5D. According to one embodiment, each comment may have an associated timestamp indicating when the comment was provided. In some embodiments, subscribers and/or users subscribed to a worksite may receive an electronic notification that a comment was provided.

FIG. 5I depicts an example rain log functionality 575 interface of the user device 500 of FIG. 5A that provides a history of precipitation at the construction site, in accordance with an embodiment of the present invention. According to one embodiment, the rain log functionality 575 may be accessed when the user select the rain log input 538 of FIG. 5D. The rain log may list several dates and may indicate a precipitation level at the specific construction site for each respective date. FIG. 5J depicts an example NPDES section 580 interface of the user device 500 of FIG. 5A that permits users to download copies of various stormwater obligations associated with the construction site by selecting a respective download input 582 for the desired document, in accordance with an embodiment of the present invention. FIG. 5K depicts an example downloaded NPDES inspection report 590 viewable via the user device 500 of FIG. 5A that is associated with the construction site, which may be accessed based on the user selecting a download input 582 associated with a specific inspection report, in accordance with an embodiment of the present invention.

FIG. 6 depicts a block diagram of an example method 600 for permission-based cloud storage and file sharing, in accordance with an embodiment of the present invention. A computing environment for permission-based cloud storage and file sharing may include a cloud-based computing network, such as a node-based network that includes a plurality of interconnected nodes. The nodes may include computing devices that are collectively programmed to interoperated based at least in part on a computing environment coordination protocol. Specifically, the nodes may include a pool of configurable computing resources (e.g., networks, network bandwidth, servers, processing, memory, storage, applications, virtual machines, and services) that can be rapidly provisioned and released in accordance with a coordination protocol. Further, at least a portion (i.e., one or more) of the plurality of interconnected computing devices provide resources and are configured to perform various functionalities related to storage and file sharing. For instance, these functionalities are depicted by the method 600.

At block 605, location-specific files (e.g., various worksite related documentation) associated with at least one worksite location are stored, via the interconnected computing devices, (e.g., such as servers) where at least one worksite location includes a construction site. For example, the location-specific files may include worksite documentation selected from the group consisting of worksite permits, site plans, worksite compliance reports, worksite inspection reports, architectural drawings, schedules, work orders, safety reports, certificates of insurance, worksite specifications, project diaries, requests for information, contracts, purchase orders, change orders, worksite drawings, progress reports, work orders, a works diary, works passing records, test results, supply registers, sample records, measurement books, attendance records, concrete pouring requests, non-conformance reports, and bills records.

At block 610, the interconnected computing devices determine that a user is attempting to access, based on the user scanning a digital image (e.g., a quick response (QR) code) via a user device and providing authentication credentials via the user device, the location-specific files associated with the at least one worksite location. For example, the user may utilize an optical instrument such as a digital camera that is configured to detect presence of a scannable object within an image. For instance, the optical instrument may include one or more lenses and one or more image sensors (e.g., a charge coupled device (CCD) sensor) configured to convert photons into an electrical signal. For example, pixels of each the image sensors may each include a photodiode (e.g., a semiconductor) that becomes electrically charged in accordance with the strength of the light that strikes the photodiode, where the electrical charge is then relayed to be converted to an electrical signal. In one embodiment, a series of pulses may be applied to the one or more image sensors to relay the accumulate charges within each photodiode in succession down a row of photodiodes to an edge of the respective image sensor. The optical instrument may be electrically coupled or otherwise integrated with a computing device (e.g., a smart phone) and be utilized by the user to scan the digital image (e.g., QR code).

The digital image may include a machine-readable matrix code (e.g. a QR code) that includes embedded data modules that include encoded data. When the digital image is scanned, the computing system of the user's computing device performs pattern recognition on the machine-readable matrix code to decipher the embedded data modules. Once the digital image is scanned, a selectable link to a URL of a website may be displayed, via the user interface. According to one embodiment, when the user selects the link a webpage is displayed, where the webpage is configured to receive authentication credentials for the user to access a user account. The user provides, via the user's computing device, authentication credentials in order to access location-specific files associated with the at least one worksite location. The authentication credentials may include, for example, a username, a password, biometric information (e.g., using facial recognition) a fingerprint, personally identifiable information, and/or various other authentication credentials. In some embodiments, the user's computing device may incorporate various authentication systems, such as those described herein, in order to authenticate the user. In some embodiments, the authentication credentials are provided in order to set up a new user account, whereas in other embodiments the authentication credentials are provided in order to access an existing user account.

At block 615 the interconnected computing devices ascertain a permitted access level of the user attempting to access the location-specific files associated with the at least one worksite location, the ascertaining being based on the authentication credentials provided. For instance, the authentication credentials may be associated with a paid subscription account that would grant the user with access to perform various functionalities associated with the location-specific files. In other instances, the authentication credentials may only be associated with a limited-access account that has limited functionalities. The cloud-based computing system may implement an access control scheme that controls access to various functionalities through an authentication process. In some instances, the cloud-based computing system may limit access to storage resources and permissions may be granted to various user accounts in accordance with preexisting rules. For instance, the rules may be associated with subscription levels that have varying costs. In ascertaining the permitted access level, access control that has been granted to a user account that is associated with the authentication credentials provided is verified. In particular, the cloud-based computing system may include a plurality of access levels that are each granted to different user accounts of a plurality of user accounts, and a designated access level is specifically authorized for the user account that is associated with the authentication credentials.

In some embodiments, the plurality of access levels include a first access level, where permitted functionalities include permission to view location-specific files while restricting ability to upload, edit, or download the location-specific files. In some embodiments, the plurality of access levels include a second access level, where permitted functionalities include permission to view, upload, edit, and download the location-specific files. Various other access levels are also contemplated herein. For instance, a third access level may be provided where administrative/primary account holders (e.g., subscription holders) restrict access to specific documents, files, folders, etc. and/or restrict specific functionalities for those documents for one or more specific users within a shared account. For instance, a company account may have different permissions for different users such that certain users (e.g., managers, supervisors, etc.) have access to the company account may have full functionality to upload, edit, download, etc., whereas other users (e.g., day laborers, temporary workers, etc.) may have restricted functionalities for some of the documents (i.e., a subset of the documents). In a non-limiting example, the general contractor, or other individual, that is the primary account holder may define the access levels granted to specific users and/or subsets of users so that, for example, certain subcontractors are permitted to upload, download, edit, etc. all documents related to their field of work, but would have restricted access to only view all other documents related to the worksite project. For instance, the primary account holder may grant the head electrician with authorization to upload, edit, download, etc. all documents related to their scope of work, but the head electrician could not upload, edit, download, etc. municipal inspection reports, which are uploaded by local municipalities. In another example, certain users may be granted authorization to upload or download documents, but would not be authorized to perform edits to existing documents.

In some embodiments, some accounts are automatically granted authorization to access worksite information and/or perform certain functionalities for all worksite projects within a predefined region. For instance, a municipal account may be granted access to view all worksite projects within that municipality, where the worksite location is defined by, for example, a zip code, an address, longitude and latitude, etc. that are input by the administrator/subscriber of an account that establishes the worksite. For instance, when a subscriber establishes a worksite and provides location information (e.g., address, longitude and latitude, zip code, etc.), then the corresponding municipality may be automatically granted a certain access level to perform certain functionalities for that worksite. Further, various account users and/or subsets of account users associated with the municipal account may be granted access to upload, edit, and download inspection reports, but would not be able to make edits to other documents such as blueprints, site plans, etc. At block 620 the interconnected computing devices provide, based on the ascertained permitted access level, corresponding access to one or more functionalities associated with the location-specific files.

In some embodiments, the interconnected computing devices are used to calculate latitude and longitude of the construction site. In one example, latitude and longitude can be calculated using various methods and algorithms such as via a GPS that receivers that receive signals from multiple satellites and use trilateration to determine the location of the construction site. In another example, latitude and longitude can be calculated using geocoding that converts an address or place name into geographic coordinates and accesses databases that include location coordinates such as the latitude and longitude. In other examples, the interconnected computing devices are configured to calculate latitude and longitude based on the earth's shape and measurements using common mathematical models such as the World Geodetic System (WGS84) that is maintained by the United States National Geospatial-Intelligence Agency. These mathematical may, in some cases, utilize trigonometry taking into account the earth's radius and the angles between a reference plan (e.g., the equator) and the construction site, among other parameters. Other examples may utilize map projections that represent the earth's curved surface on a two-dimensional map and convert the coordinates of a point on the map to latitude and longitude values. In some examples, combinations of each of these example calculation methods may be utilized.

Once the latitude and longitude of the construction site are calculated, the interconnected computing devices may input these coordinates into a weather application programming interface (API) or weather data services. Some weather data services may utilize spatial interpolation of multiple data sources to estimate the daily precipitation total for the latitude and longitude of the construction site. The interconnected computing devices track, log, store, and/or report the daily precipitation totals determined to occur at the latitude and longitude of the construction site. Further, the stored daily precipitation totals may be accessible to the user based on the ascertained permitted access level.

FIG. 7 depicts a block diagram of an example method 700 for permission-based cloud storage and file sharing, in accordance with an embodiment of the present invention. At block 705 executable code causes the at least one processor to detect, via a user device, a digital image being scanned that comprises machine-readable matrix code (e.g., a QR code) that includes embedded data modules, where the embedded data modules comprise encoded data to access a selectable link to a webpage. In order to scan the digital image, the user may utilize an optical instrument such as a digital camera that is configured to detect presence of a scannable object within an image. For instance, the optical instrument may be electrically connected to or otherwise integrated with a computing device (e.g., a smart phone) and may include one or more lenses and one or more image sensors (e.g., a charge coupled device (CCD) sensor) configured to convert photons into an electrical signal and perform operations such as those described herein for optical instrumentation.

When the digital image is scanned, the computing system of the user's computing device performs pattern recognition on the machine-readable matrix code (e.g., QR code) to decipher the embedded data modules. At block 710, the executable code causes the at least one processor to display, via a user interface of the user device (e.g., a smart phone), a selectable link to a webpage configured to receive authentication credentials, and if the user selects the link at block 715 the computing device receives a user input selecting the selectable link to the webpage. The webpage is configured to receive authentication credentials for the user to access a user account. According to one embodiment, when the user provides the authentication credentials in order to access location-specific files associated with the at least one worksite location, the executable code causes the at least one processor, at block 720 to display, via the user interface of the computing device, the webpage configured to receive authentication credentials to access location-specific files associated with a construction site.

At block 725, the at least one processor receives, via the user device, a user authentication credentials from a user of the user device The authentication credentials received may include, for example, a username, a password, biometric information (e.g., using facial recognition) a fingerprint, personally identifiable information, and/or various other authentication credentials. In some embodiments, the user's computing device may incorporate various authentication systems, such as those described herein, in order to authenticate the user. In some embodiments, the authentication credentials are provided in order to set up a new user account, whereas in other embodiments the authentication credentials are provided in order to access an existing user account. At block 730, the at least one processor provides, via the user interface, access to one or more functionalities related to the location-specific files associated with the construction site.

According to various embodiments, the location-specific files may include worksite documentation selected from the group consisting of worksite permits, site plans, worksite compliance reports, worksite inspection reports, architectural drawings, schedules, work orders, safety reports, certificates of insurance, worksite specifications, project diaries, requests for information, contracts, purchase orders, change orders, worksite drawings, progress reports, work orders, a works diary, works passing records, test results, supply registers, sample records, measurement books, attendance records, concrete pouring requests, non-conformance reports, and bills records.

The terminology used herein is for describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages. An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible. The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®,” “Windows®,” “macOS®,” “iOS®,” “Android®,” and the like may be subject to trademark rights in various jurisdictions throughout the world and are used here only in reference to the products or services properly denominated by the marks to the extent that such trademark rights may exist.

What is claimed is:

1. A computing environment for permission-based cloud storage and file sharing, the environment comprising:
a cloud-based computing network comprising a plurality of interconnected computing devices collectively programmed to interoperate based at least in part on a computing environment coordination protocol, wherein at least a portion of the plurality of interconnected computing devices is configured to:
store location-specific files associated with at least one worksite location, wherein the at least one worksite location comprises a construction site;
determine that a user is attempting to access, based on the user scanning a digital image via a user device and providing authentication credentials via the user device, the location-specific files associated with the at least one worksite location;
ascertain a permitted access level of the user attempting to access the location-specific files associated with the at least one worksite location, the ascertaining being based on the authentication credentials provided; and
provide, based on the ascertained permitted access level, corresponding access to one or more functionalities associated with the location-specific files.

2. The computing environment of claim 1, wherein the digital image comprises a machine-readable matrix code comprising embedded data modules that comprise encoded data.

3. The computing environment of claim 2, wherein the machine-readable matrix code comprises a quick response (QR) code.

4. The computing environment of claim 2, wherein the determining that the user is attempting to access the location-specific files is further based on the user device:
performing pattern recognition on the machine-readable matrix code to decipher the embedded data modules;
displaying a selectable link to a webpage configured to receive the authentication credentials; and
receiving the authentication credentials from the user.

5. The computing environment of claim 1, wherein the location-specific files comprise worksite documentation selected from the group consisting of worksite permits, site plans, worksite compliance reports, worksite inspection reports, architectural drawings, schedules, work orders, safety reports, certificates of insurance, worksite specifications, project diaries, requests for information, contracts, purchase orders, change orders, worksite drawings, progress reports, work orders, a works diary, works passing records, test results, supply registers, sample records, measurement books, attendance records, concrete pouring requests, non-conformance reports, and bills records.

6. The computing environment of claim 1, wherein the authentication credentials comprise personally identifiable information.

7. The computing environment of claim 1, wherein the ascertaining the permitted access level is based on verifying access control granted to a user account that is associated with the authentication credentials, the permitted access level being selected from a plurality of access levels each granted to different user accounts of a plurality of user accounts.

8. The computing environment of claim 7, wherein the plurality of access levels comprise:
a first access level, wherein the one or more functionalities comprise permission to view the location-specific files while restricting ability to upload, edit, or download the location-specific files; and
a second access level, wherein the one or more functionalities comprise permission to view, upload, edit, and download the location-specific files.

9. The computing environment of claim 1, wherein at least a portion of the plurality of interconnected computing devices is further configured to:
calculate latitude and longitude of the construction site;
track daily precipitation totals determined to occur at the latitude and longitude of the construction site; and
store the daily precipitation totals.

10. The computing environment of claim 9, wherein the stored daily precipitation totals are accessible to the user based on the ascertained permitted access level.

11. A computing system for permission-based cloud storage and file sharing, the system comprising:
at least one processor;
a communication interface communicatively coupled to the at least one processor; and
a memory device storing executable code that, when executed, causes the at least one processor to:
detect, via a user device, a digital image being scanned that comprises machine-readable matrix code that includes embedded data modules, wherein the embedded data modules comprise encoded data to access a selectable link to a webpage;
display, via a user interface of the user device, the selectable link to the webpage configured to receive authentication credentials;
receive, via the user device, a user input selecting the selectable link to the webpage;
display, via the user interface, the webpage configured to receive authentication credentials to access location-specific files associated with a construction site;
receive, via the user device, a user authentication credentials from a user of the user device; and
provide, via the user interface, access to one or more functionalities related to the location-specific files associated with the construction site.

12. The computing system of claim 11, wherein the machine-readable matrix code comprises a quick response (QR) code.

13. The computing system of claim 11, wherein the scanning comprises performing pattern recognition on the machine-readable matrix code to decipher the embedded data modules.

14. The computing system of claim 11, wherein the location-specific files comprise worksite documentation selected from the group consisting of worksite permits, site plans, worksite compliance reports, worksite inspection reports, architectural drawings, schedules, work orders, safety reports, certificates of insurance, worksite specifications, project diaries, requests for information, contracts, purchase orders, change orders, worksite drawings, progress reports, work orders, a works diary, works passing records, test results, supply registers, sample records, measurement books, attendance records, concrete pouring requests, non-conformance reports, and bills records.

15. The computing system of claim 11, wherein the user authentication credentials comprise personally identifiable information of the user.

16. A computer-implemented method for permission-based cloud storage and file sharing, the method comprising:
storing location-specific files associated with at least one worksite location, wherein the at least one worksite location comprises a construction site;
determining that a user is attempting to access, based on the user scanning a digital image via a user device and providing authentication credentials via the user device, the location-specific files associated with the at least one worksite location;
ascertaining a permitted access level of the user attempting to access the location-specific files associated with the at least one worksite location, the ascertaining being based on the authentication credentials provided; and
providing, based on the ascertained permitted access level, corresponding access to one or more functionalities associated with the location-specific files.

17. The computer-implemented method of claim 16, wherein the digital image comprises a machine-readable matrix code comprising embedded data modules that comprise encoded data.

18. The computer-implemented method of claim 17, wherein the machine-readable matrix code comprises a quick response (QR) code.

19. The computer-implemented method of claim 16, wherein the location-specific files comprise worksite documentation selected from the group consisting of worksite permits, site plans, worksite compliance reports, worksite inspection reports, architectural drawings, schedules, work orders, safety reports, certificates of insurance, worksite specifications, project diaries, requests for information, contracts, purchase orders, change orders, worksite drawings, progress reports, work orders, a works diary, works passing records, test results, supply registers, sample records, measurement books, attendance records, concrete pouring requests, non-conformance reports, and bills records.

20. The computer-implemented method of claim 16, wherein the method further comprises:
calculating latitude and longitude of the construction site;
tracking daily precipitation totals determined to occur at the latitude and longitude of the construction site; and
storing the daily precipitation totals.
